(19) United States
(12) Patent Application Publication
(10) Pub. No.: US 2022/0176750 A1
(43) Pub. Date: Jun. 9, 2022

(54) TIRE, TIRE WEAR DETECTION SYSTEM INCLUDING THE SAME, METHOD TO DETECT TIRE WEAR

(71) Applicant: Nexen Tire America Inc., Diamond Bar, CA (US)

(72) Inventors: Aaron Neumann, Hudson, OH (US); Nathan Billy, Medina, OH (US); Dong Y. Lee, Copley, OH (US); Lin Kung, Richfield, OH (US)

(21) Appl. No.: 17/117,024

(22) Filed: Dec. 9, 2020

(51) Int. Cl. B60C 11/24

(52) U.S. Cl. CPC B60C 11/243

(57) ABSTRACT

A tire for a vehicle includes: a tread extending in a circumferential direction about a rotational axis of the tire; and wear indicators disposed in the tread and spaced apart from each other to be arranged in the circumferential direction. A harmonic noise signal caused by the tire when the tire rolls on a road surface to move the vehicle has neighboring first and second frequency peaks in a frequency spectrum of the harmonic noise signal, and the number of the wear indicators is in a range of 16 to 96 to generate, and when the tire rolls to move the vehicle at a speed in a target range, the wear indicators cause an additional frequency peak positioned between the first and second frequency peaks in the frequency spectrum when the tread is worn to reach a wear threshold.

### BACKGROUND

### Field

Exemplary implementations of the invention relate generally to a tire, and more specifically, to a tire, a tire wear detection system including the same, a method to detect tire wear.

### Discussion of the Background

As a tire gradually runs along the ground, its tread that is in contact with the ground becomes worn away through friction. This wear notably causes a reduction in the depth of tread patterns formed in the tread.

For obvious safety reasons, it is important to check tire tread wear before it becomes excessive and too significantly impairs tire performance, notably on a road surface that is wet or covered with snow.

To make it easier to check the tire wear, the tire is commonly equipped with visual tread wear indicators that allow the user to differentiate between several levels of wear.

One disadvantage with this type of wear indicator is that it requires vehicle users' vigilance to check the tire conditions regularly. However, many drivers, omitting such checks, change their tires too late, until for example, a mechanic checks the tire wear during the vehicle safety inspection.

The above information disclosed in this Background section is only for understanding of the background of the inventive concepts, and, therefore, it may contain information that does not constitute prior art.

### SUMMARY

Tires and tire wear detection systems including the same constructed according to the principles and exemplary implementations of the invention are capable of improving vehicle safety. For example, the tire may include tread features to generate an additional frequency peak into a frequency spectrum of the harmonic signals of noises that the tire generates when the tire rolls to move a vehicle.

Tire wear detection systems and methods to detect tire wear according to the principles and exemplary implementations of the invention are capable of generating an alert signal to indicate a worn tire with relatively high reliability. For example, the alert signal is u) generated in response to the additional frequency peak positioned between the first and the second frequency peaks of the frequency spectrum of the harmonic noise signal. For example, the alert signal is generated further based on vehicle speed.

Additional features of the inventive concepts will be set forth in the description which follows, and in part will be apparent from the description, or may be learned by practice of the inventive concepts.

According to one aspect of the invention, a tire for a vehicle includes: a tread extending in a circumferential direction about a rotational axis of the tire; and wear indicators disposed in the tread and spaced apart from each other to be arranged in the circumferential direction. A harmonic noise signal caused by the tire when the tire rolls on a road surface to move the vehicle has neighboring first and second frequency peaks in a frequency spectrum of the harmonic noise signal, and the number of the wear indicators is in a range of 16 to 96 to generate, and when the tire rolls to move the vehicle at a speed in a target range, the wear indicators cause an additional frequency peak positioned between the first and second frequency peaks in the frequency spectrum when the tread is worn to reach a wear threshold.

The first and second frequency peaks may have substantially constant frequencies regardless of the speed of the vehicle.

The harmonic noise signal may have a plurality of frequency peaks in the frequency spectrum, and the first and second frequency peaks may have lowest frequencies from among the plurality of frequency peaks.

The tread may include tread patterns defining grooves, the grooves may be spaced apart from each other to be arranged in the circumferential direction, and the wear indicators may include tread features disposed on surfaces of the grooves.

The wear indicators may include tread features buried in the tread.

The wear indicators may be configured to generate an acoustic signal to provide the additional frequency peak in the frequency spectrum when the tread is worn to reach the wear threshold.

The first frequency peak may have a frequency of about 200 Hz, and the second frequency peak may have a frequency of about 400 Hz.

The number of the wear indicators may be in a range of 24 to 56.

The number of the wear indicators may be 32.

According to another aspect of the invention, a tire wear detection system for a vehicle includes: a tire including: a tread extending in a circumferential direction about a rotational axis of the tire; and wear indicators disposed in the tread and spaced apart from each other to be arranged in the circumferential direction, the number of the wear indicators being in a range of 16 to 96; at least one sensor to generate a harmonic noise signal in association with the tire when the tire rolls on a road surface to move the vehicle, the harmonic noise signal having neighboring first and second frequency peaks in a frequency spectrum of the harmonic noise signal; at least one processor to generate an alert signal based on detection of an additional frequency peak caused by the wear indicators and positioned between the first and second frequency peaks in the frequency spectrum.

The first and second frequency peaks may have substantially constant frequencies regardless of the speed of the vehicle.

The harmonic noise signal may have a plurality of frequency peaks in the frequency spectrum, and the first and second frequency peaks may have lowest frequencies from among the plurality of frequency peaks.

The at least one processor may be configured to generate the alert signal further based on whether the vehicle moves at a speed in a target range.

The at least one processor may be configured to activate the detection of the additional frequency peak in response to the speed of the vehicle being in the target range.

The at least one processor may be configured to calculate the target range depending on the number of the wear indicators and a diameter of the tire, the target range may be inversely proportional to the number of the tread features and proportional to the diameter of the tire.

The at least one processor may be configured to determine the number of the wear indicators and the diameter of the tire based on input information.

The tire wear detection system may further include a storage medium to store indices and diameters corresponding to tire identifiers. The at least one processor may be configured to: select one of the indices and one of the diameters that correspond to one of the tire identifiers matched with the input information; and determine the selected index and the selected diameter as the number of the wear indicators and the diameter of the tire.

The tire wear detection system may further include a storage medium to store speed ranges corresponding to tire identifiers. The at least one processor may be configured to: select one of the speed ranges which corresponds to one of the tire identifiers matched with input information; and determine the selected speed range as the target range.

The at least one sensor may include an acoustic sensor to detect a harmonic acoustic signal generated by the tire to generate the harmonic noise signal.

According to still another aspect of the invention, a method of generating an alert signal to indicate a tire worn to reach a wear threshold includes steps of: generating harmonic noise signal in association with the tire when the tire rolls on a road surface to move a vehicle, the harmonic noise signal having neighboring first and second frequency peaks in a frequency spectrum of the harmonic noise signal, wherein the tire includes: a tread extending in a circumferential direction about a rotational axis of the tire; and wear indicators disposed in the tread and spaced apart from each other to be arranged in the circumferential direction, the number of the wear indicators being in a range of 16 to 96; and generating an alert signal based on detection of an additional frequency peak caused by the wear indicators and positioned between the first and second frequency peaks in the frequency spectrum.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a side view of an exemplary embodiment of a tire constructed according to the principles of the invention.

FIG. 2 is a cross-sectional view of a portion of an exemplary embodiment of a wheel assembly including the tire of FIG. 1.

FIG. 3 is a plan view of a portion of an exemplary embodiment of the tread section of FIG. 2 when viewed in a radial direction.

FIG. 4 is a cross-sectional view of a portion of another exemplary embodiment of the wheel assembly including the tire of FIG. 1.

FIG. 5 is a graph of a frequency spectrum of each of acoustic noise signals experimentally obtained at different vehicle speeds.

FIGS. 6A through 6E are frequency-spectrum graphs of acoustic noise signals experimentally obtained at various vehicle speeds when the tire is worn to allow the tread features of FIG. 1 to generate an additional acoustic signal.

FIG. 7 is a block diagram of an exemplary embodiment of a vehicle system constructed according to the principles of the invention.

FIG. 8 is a flowchart of an exemplary embodiment of a method of generating an alert signal to indicate a worn-out tire.

FIG. 9 is a block diagram of another exemplary embodiment of a vehicle system constructed according to the principles of the invention.

FIG. 10 is a conceptual view illustrating tire information stored in the storage medium of FIG. 9.

FIG. 11 is a flowchart of another exemplary embodiment of a method of generating an alert signal to indicate a tire worn out.

FIG. 12 is a flowchart of an exemplary embodiment of the step S1120 of FIG. 11.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one element relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

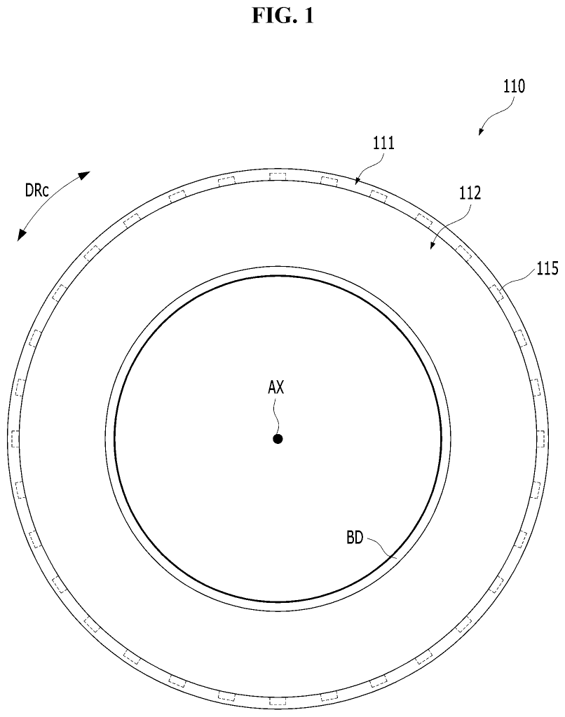

FIG. 1 is a side view of an exemplary embodiment of a tire constructed according to the principles of the invention.

Referring to FIG. 1, a tire 110 may include a tread section 111, a bead BD, and a pair of sidewalls such as a sidewall 112 extending from the tread section 111 to the bead BD. In an exemplary embodiment, the tire 100 may be a pneumatic tire. In an exemplary embodiment, the tire 100 may be used on light vehicles such as passenger cars and light trucks.

The tire 110 may be mounted on a vehicle wheel through the bead BD. The bead BD may have a shape suitable for being engaged with the vehicle wheel, and may enable the tire 110 to be mounted on the vehicle wheel. The bead BD may be formed along a circumferential direction DRc about a rotational axis AX of the tire 110.

The tread section 111 extends in the circumferential direction DRc at the outermost surface of the tire 110 to come into contact with a ground. The tread section 111 may be configured to deliver a driving force and braking force of the vehicle wheel and/or a corresponding vehicle to the ground. The tread section 111 includes a thick rubber layer having tread patterns for steering stability, traction, and braking.

The pair of sidewalls extends from an end of the tread section 111 which is, for example, a tire shoulder. The pair of sidewalls may provide lateral stability for the tire 110, and may transmit engine torque from the vehicle wheel to the tread section 111. In addition, the pair of sidewalls may perform a bending and stretching motion to increase ride comfort. The pair of sidewalls may have a symmetric structure with respect to the tread section 111.

The tire 110 further includes acoustic wear indicators, which is in the form of tread features 115 disposed in the tread section 111, configured to create an acoustic signal in case where the tire 110 and/or the tread section 111 are worn to reach a wear threshold. Each of the tread features 115 may have various shapes suitable for creating the acoustic signal. Regarding the shapes of the tread features, U.S. Pat. No. 7,391,306 is hereby incorporated by reference.

A control system of the vehicle may detect the acoustic signal using at least one sensor associated with the tire 110. When the tire 110 and/or the tread section 111 are worn out to reach the wear threshold, the vehicle control system may detect the tire wear based on the acoustic signal and generate an alert signal. The vehicle control system may then notify the user to replace the tire 110 and/or perform necessary operations in response to the alert signal, thereby improving vehicle safety. Therefore, the acoustic signal generated by the tread features 115 and/or the alert signal generated based on the acoustic signal need to have relatively high reliability to indicate tire and/or tread wear especially for an autonomous vehicle.

The tread features 115 are equally spaced apart from each other to be arranged in the circumferential direction DRc. The tread features 115 may be provided to generate the acoustic signal causing a frequency peak within a specific frequency range when the tire 110 rolls on a road surface to move the vehicle at a speed in a target range. To generate the acoustic signal causing the frequency peak, the number of the tread features 115 arranged in the circumferential direction DRc may range from 16 to 96. In an exemplary embodiment, the number of the tread features 115 may be in a range of 24 to 56. In an exemplary embodiment, the number of the tread features 115 may be 32.

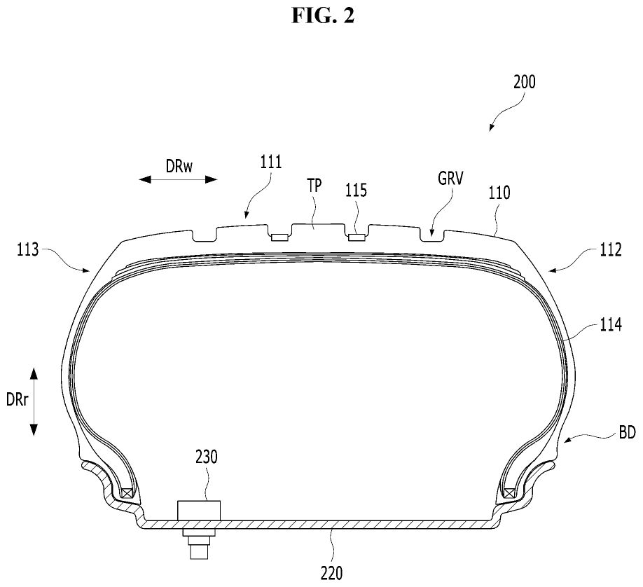

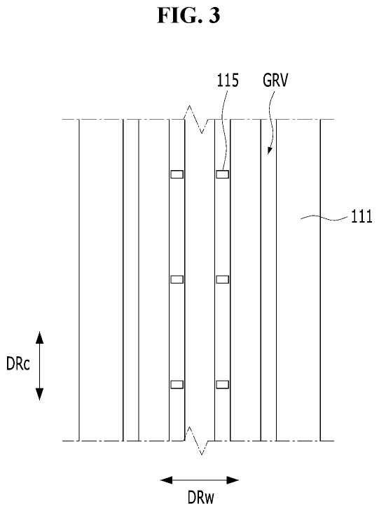

FIG. 2 is a cross-sectional view of a portion of an exemplary embodiment of a wheel assembly including the tire of FIG. 1. FIG. 3 is a plan view of a portion of an exemplary embodiment of the tread section of FIG. 2 when viewed in a radial direction.

Referring to FIGS. 2 and 3, a wheel assembly 200 may include the tire 110 and a vehicle wheel 220. The tire 110 is mounted on the vehicle wheel 220.

The tire 110 may include a tread section 111, a pair of sidewalls 112 and 113, a carcass layer 114, tread features 115, and a bead BD.

The carcass layer 114 is positioned inside the tread section 111 and the sidewalls 112 and 113, and forms the framework of the tire 100. The carcass layer 114 may define a tire cavity inside the tire 110, and may maintain air pressure of the tire cavity to endure load and impact on the tire 110. In an exemplary embodiment, the carcass layer 114 may include one or more layers overlapping each other.

The tread section 111 includes tread patterns TP protruded from the surface of the tire section 111 in a radial direction DRr of the tire 110 and/or the wheel assembly 200 to contact the ground. The tread patterns TP may define grooves GRV. The grooves GRV may help drainage while driving over wet roads. The grooves GRV may include a groove extending in the circumferential direction DRc as shown in FIG. 3. In an exemplary embodiment, the grooves GRV may further include a groove extending in a width direction DRw of the tread section 111 and/or the tire 110.

The grooves GRV defined by the tread patterns TP may be arranged in the width direction DRw. Also, the grooves GRV may be arranged in the circumferential direction DRc. In FIG. 3, each of four groups of the grooves GRV is arranged in the circumferential direction DRc. Accordingly, in FIG. 2, the four grooves GRV are shown as being formed in the tread section 111.

The tread features 115 may be disposed on the surfaces of at least some of the grooves GRV. Accordingly, the tread features 115 disposed in the grooves GRV may be spaced apart from the road surface, and may be adjacent to and/or contact the road surface when the tread patterns TP are worn to reach a wear threshold.

In an exemplary embodiment, the tread features 115 may be provided in at least one of the groups of the grooves GRV arranged in the circumferential direction DRc and may not be provided in the other ones of the groups of the grooves GRV arranged in the circumferential direction DRc, as seen in FIGS. 2 and 3. In another exemplary embodiment, the tread features 115 may be provided in all the grooves GRV of the tread section 111.

At least one sensor 230 may be provided in association with the wheel assembly 200. For example, the at least one sensor 230 may be disposed within an interior of the wheel assembly 200, and/or may be disposed outside the wheel assembly 200. The at least one sensor 230 may be mounted on the vehicle wheel 220 and coupled to the vehicle control system. In an exemplary embodiment, the vehicle control system includes a tire pressure monitoring system (TPMS) and the at least one sensor 230 may be coupled to and/or included in the tire pressure monitoring system. For example, at least a portion of the tire pressure monitoring system may be mounted on the vehicle wheel 220, and the at least one sensor 230 may be integrated with the tire pressure monitoring system.

The at least one sensor 230 may detect a harmonic tire noise caused by the tire 110 and/or the wheel assembly 200 when the wheel assembly 200 rolls on the road surface to move the vehicle, and generate a harmonic noise signal depending on the detected harmonic tire noise. The at least one sensor 230 may be an acoustic sensor to detect a harmonic acoustic signal of the tire to generate the harmonic noise signal. For example, the at least one sensor 230 may include a microphone to measure the acoustic noise signal at level in a range of 0 to 120 decibel (dB) and at frequencies in a range of 150 to 400 hertz (Hz). The acoustic noise signal may be processed by the tire pressure monitoring system and/or vehicle control system to determine a given condition of the tire 110 when the vehicle moves.

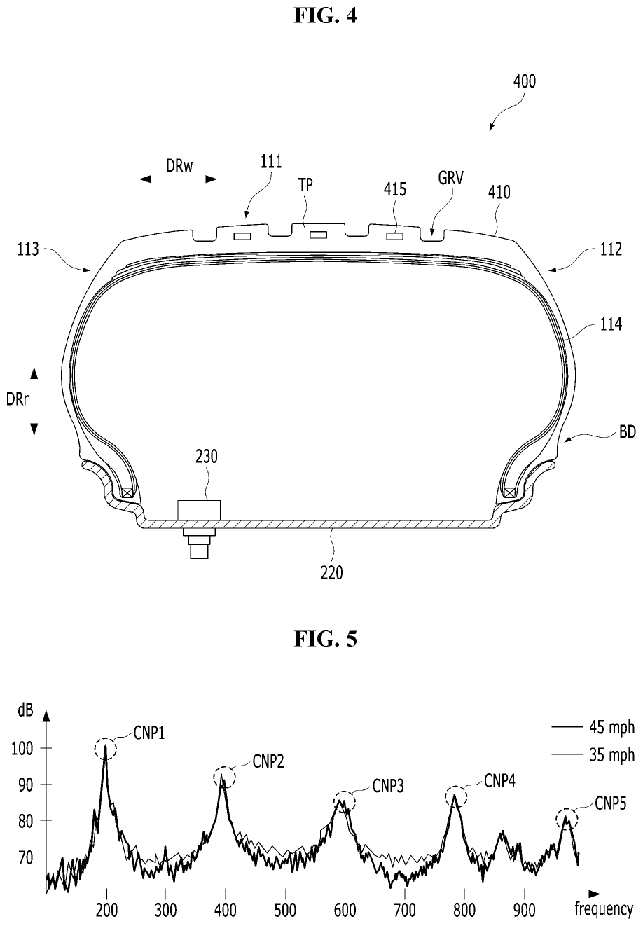

FIG. 4 is a cross-sectional view of a portion of another exemplary embodiment of the wheel assembly including the tire of FIG. 1.

Referring to FIG. 4, a wheel assembly 400 includes a tire 410 and a vehicle wheel 220. The tire 410 may be configured the same as the tire 210 of FIG. 2 except for tread features 415.

The tread features 415 may be buried in the tread section 111 and configured to create an acoustic signal when exposed. In an exemplary embodiment, the tread features 415 may be disposed inside the tread patterns TP. In this manner, the tread features 415 may be spaced apart from the road surface by the mass of the tread patterns TP, and may be exposed to be adjacent and/or contact the road surface when the tread patterns TP are worn to reach the wear threshold.

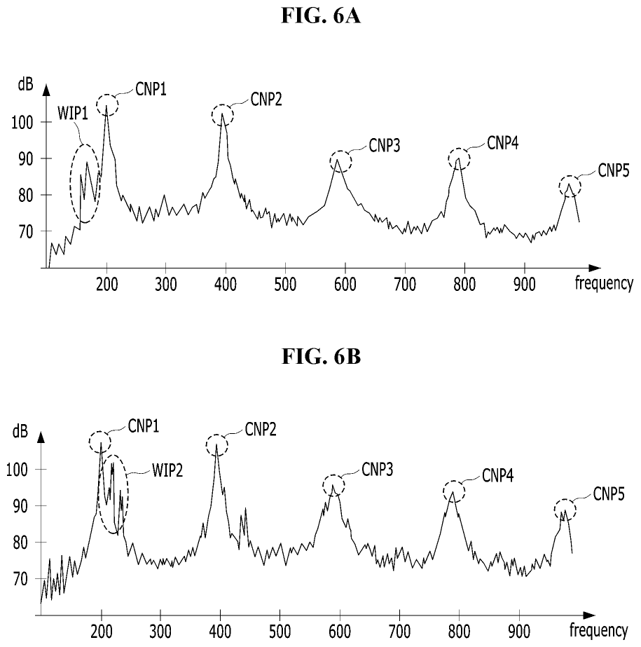

FIG. 5 is a graph of a frequency spectrum of each of acoustic noise signals experimentally obtained at different vehicle speeds. In FIG. 5, the horizontal axis denotes a frequency, and the vertical axis denotes an energy level in a unit of dB, which may be a sound pressure level.

Referring to FIG. 5, when the vehicle moves at 35 miles per hour (mph), the frequency spectrum of the acoustic noise signal may have a plurality of frequency peaks which are cavity noise peaks such as first to fifth cavity noise peaks CNP1 to CNP5 according to the resonance effect of the tire cavity.

The frequency peaks each may be defined as a frequency waveform having an energy level higher than an energy level at other frequencies. The frequency peaks may be determined in various manners known in the art. For example, the frequency peaks each may have an energy level higher than a value obtained by multiplying a certain ratio and an average energy level of the frequency spectrum and/or a value obtained by multiplying a certain ratio and an average energy level of adjacent frequencies of the frequency spectrum.

The acoustic noise signal, which is obtained when the vehicle moves at 45 mph, may cause the frequency spectrum having first to fifth cavity noise peaks CNP1 and CNP5 whose frequencies are the same as those of the frequency spectrum at 35 mph. As such, the first to fifth cavity noise peaks CNP1 and CNP5 may have substantially constant frequencies regardless of the vehicle speed.

In an exemplary embodiment, the first cavity noise peak has a frequency of about 200 Hz, and the second cavity noise peak has a frequency of about 400 Hz.

The first and second cavity noise peaks CNP1 and CNP2 have the lowest frequencies from among the first to fifth cavity noise peaks CNP1 to CNP5. The first and second cavity noise peaks CNP1 and CNP2 may be have energy levels higher than the other cavity noise peaks CNP3 to CNP5, and therefore may be more detectable.

If a tire includes tread features causing an additional frequency peak having a frequency lower than the first cavity noise peak CNP1, an alert signal generated based on the additional frequency peak may have relatively low reliability due to various external factors associated with the tire. For example, the tire rolling with foreign substances may cause an undesired additional frequency peak having a relatively low frequency, and the alert signal may be generated due to the undesired frequency peak even if the tire is not worn to reach the wear threshold and the tread features do not provide the additional frequency peak.

The applicant discovered that external factors causing the undesired frequency peak may have a frequency lower than the first cavity noise peak CNP1, even if the vehicle moves at a relatively high speed. According to one or more exemplary embodiments, the tire 110 may include the tread features 115 in a range of 16 to 96, and more specifically, in a range of 24 to 56 to generate an additional frequency peak, which is in the form of a wear indication peak positioned between the first and second cavity noise peaks CNP1 and CNP2 in the frequency spectrum when the tire 110 rolls to move the vehicle at a speed in a target range. Accordingly, the wear indication peak may be distinguishable from the undesired frequency peak having a frequency lower than the first cavity noise peak CNP1. Thus, the alert signal generated based on detection of the wear indication peak may have relatively high reliability to indicate tire and/or tread wear.

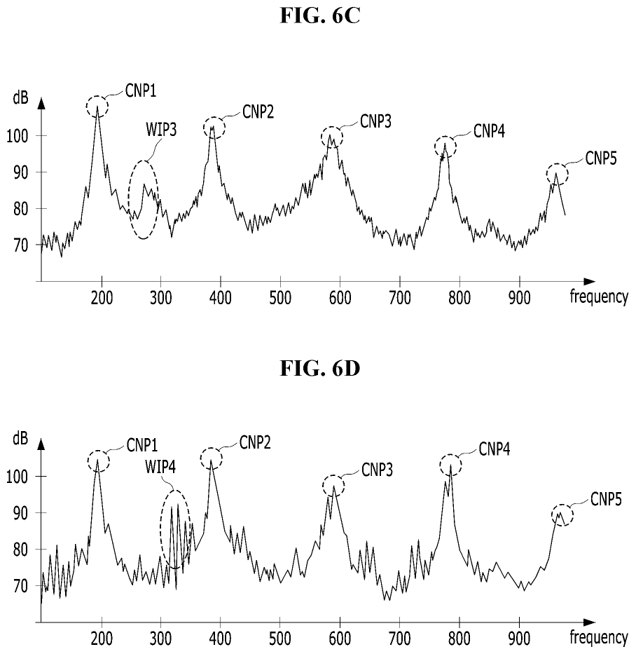

FIGS. 6A through 6E are frequency-spectrum graphs of acoustic noise signals experimentally obtained at various vehicle speeds in case where the tire is worn to allow the tread features of FIG. 1 to generate additional acoustic signal. In FIGS. 6A through 6E, the horizontal axis denotes a frequency, and the vertical axis denotes an energy level in a unit of dB, which may be a sound pressure level.

Referring to FIG. 6A, when the vehicle moves at 25 mph, the frequency spectrum may include a first wear indication peak WIP1 having a frequency lower than the first cavity noise peak CNP1.

Referring to FIG. 6B, when the vehicle moves at 35 mph, the frequency spectrum may include a second wear indication peak WIP2 having a frequency higher than the first wear indication peak WIP1 of FIG. 6A. The frequency of the wear indication peak increases as the vehicle speed increases. The second wear indication peak WIP2 may be positioned between the first and second cavity noise peaks CNP1 and CNP2.

Referring to FIG. 6C, when the vehicle moves at 45 mph, the frequency spectrum may include a third wear indication peak WIP3 positioned between the first and second cavity noise peaks CNP1 and CNP2. Referring to FIG. 6D, when the vehicle moves at 55 mph, the frequency spectrum may include a fourth wear indication peak WIP4 positioned between the first and second cavity noise peaks CNP1 and CNP2. The third wear indication peak WIP3 is higher than the second wear indication peak WIP2 and the fourth wear indication peak WIP4 is higher than the third wear indication peak WIP3.

Referring to FIG. 6E, when the vehicle moves at a speed higher than 55 mph, such as 75 mph, the frequency spectrum may include a fifth wear indication peak WIP5 having a frequency higher than the second cavity noise peak CNP2.

As such, the tread features 115 may generate the wear indication peak such as the second to fourth wear indication peaks WIP2 to WIP4 of FIGS. 6B to 6D positioned between the frequencies of the first and second cavity noise peaks CNP1 and CNP2 when the vehicle moves at a speed in a target range such as a range of about 35 mph to 55 mph.

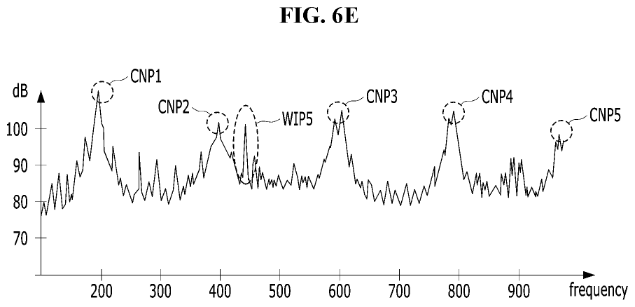

FIG. 7 is a block diagram of an exemplary embodiment of a vehicle system constructed according to the principles of the invention.

Referring to FIG. 7, a vehicle control system 700 may include a tire wear detection system, which is in the form of a tire pressure monitoring system 710, and a main controller 720.

The tire pressure monitoring system 710 may include a local controller 711, an acoustic sensor 712, a pressure sensor 713, a power supply 714, and a transmitter 715.

The local controller 711 controls overall operations of the tire pressure monitoring system 710. The local controller 711 and/or the tire pressure monitoring system 710 may operate in response to a control signal from the main controller 720. The local controller 711 may be implemented by at least one processor configured to perform the operations of the local controller 711 described herein.

The local controller 711 may communicate with the acoustic sensor 712 and the pressure sensor 713. The local controller 711 may process signals, data, and/or information received from the acoustic sensor 712 and the pressure sensor 713 to generate signals, data, and/or information. The local controller 711 may transfer the processed signals, data, and/or information to the main controller 720 through the transmitter 715.

The acoustic sensor 712 may be disposed in and/or adjacent to the vehicle wheel. For example, the acoustic sensor 712 may be provided as the at least one sensor 230 of FIG. 2. The acoustic sensor 712 may detect a harmonic tire noise caused by the tire to provide a harmonic noise signal to the local controller 711. The harmonic noise signal has the plurality of cavity noise peaks CNP1 to CNP5 of FIG. 5 in the frequency spectrum.

In an exemplary embodiment, the acoustic sensor 712 may be coupled to the pressure sensor 713 to communicate with the local controller 711 through the pressure sensor 713. In an exemplary embodiment, the acoustic sensor 712 and the pressure sensor 713 may communicate with the local controller 711 through a common channel CH. In an exemplary embodiment, the acoustic sensor 712 may be integrated with the pressure sensor 713 and/or the tire pressure monitoring system 710.

The pressure sensor 713 may detect air pressure of the tire cavity. The pressure sensor 713 may be mounted on the vehicle wheel. The power supply 714 may provide a power source to the components of the tire pressure monitoring system 710. The transmitter 715 may provide an interface to the main controller 720.

The local controller 711 may receive the harmonic noise signal from the acoustic sensor 712 and generate the frequency spectrum of the harmonic noise signal. The local controller 711 may monitor the frequency spectrum to detect whether the wear indication peak, such as the second to fourth wear indication peaks WIP2 to WIP4 of FIGS. 6B to 6D, is generated and positioned between first and second frequencies of the first and second cavity noise peaks CNP1 and CNP2.

The local controller 711 may generate an alert signal based on the detection of the wear indication peak positioned between the first and second frequencies, and transfer the alert signal to the main controller 720 through the transmitter 715.

In an exemplary embodiment, the main controller 720 may receive the harmonic noise signal from the tire pressure monitoring system 710, and may perform the operations of detecting the wear indication peak and generating the alert signal based on the detection of the wear indication peak.

In an exemplary embodiment, the first and second frequencies of the first and second cavity noise peaks CNP1 and CNP2 may be set and/or stored in the tire pressure monitoring system 710 and/or the vehicle system 700. As described with reference to FIG. 5, the frequencies of the cavity noise peaks CNP1 and CNP5 may be substantially constant regardless of the vehicle speed. The local controller 711 and/or the main controller 720 may generate the frequency spectrum of the harmonic noise signal when the vehicle moves, and may detect the neighboring first and second cavity noise peaks CNP1 and CNP2 from among the cavity noise peaks CNP1 to CNP5.

In an exemplary embodiment, at least a portion of the tire pressure monitoring system 710 may be mounted on the vehicle wheel. For example, the body of the at least one sensor 230 of FIG. 2 may be used for at least a portion of the tire pressure monitoring system 710.

The main controller 720 may control overall operations of the vehicle system 700. The main controller 720 may be implemented by at least one processor and/or a memory associated with the at least one processor. The main controller 720 may notify the user to replace the tire in response to the alert signal, and may transfer a command signal to other components of the vehicle system 700.

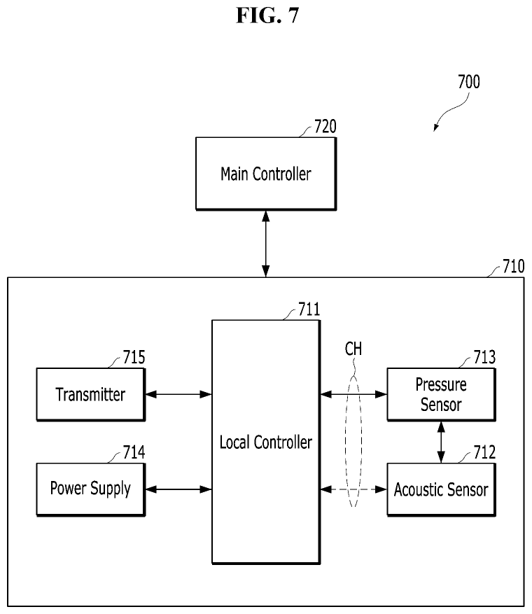

FIG. 8 is a flowchart of an exemplary embodiment of a method of generating an alert signal to indicate a worn-out tire.

Referring to FIG. 8, at step S810, a harmonic noise signal is generated using an acoustic sensor associated with a tire when the tire rolls to move the vehicle. The tire includes tread features in a range of 16 to 96, and more specifically, in a range of 24 to 56, which cause a wear indication peak in a frequency spectrum of the harmonic noise signal when the tread section of the tire is worn to reach a wear threshold.

At step S820, an alert signal is generated based on detection of the wear indication peak positioned between first and second frequencies of the first and second cavity noise peaks CNP1 and CNP2 of FIG. 5. The frequency spectrum may be obtained from the harmonic noise signal and may be monitored to detect whether the wear indication peak is generated and positioned between the first and second frequencies.

The steps S810 and S820 may be performed by the local controller 711 and/or the main controller 720 of the FIG. 7.

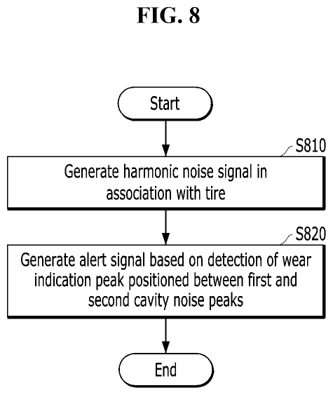

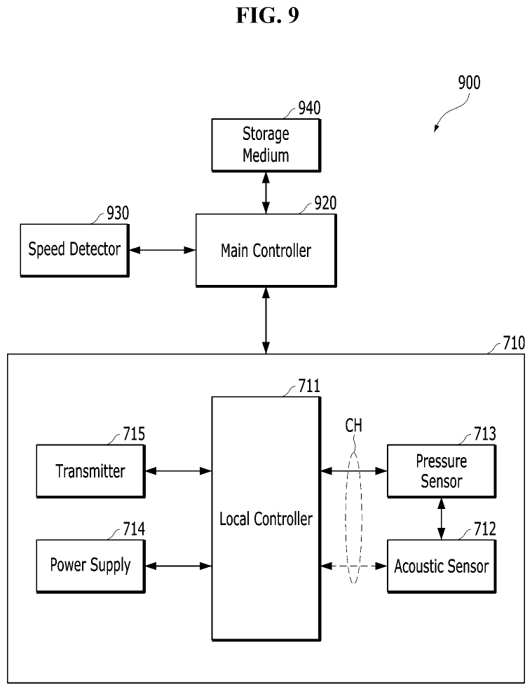

FIG. 9 is a block diagram of another exemplary embodiment of a vehicle system constructed according to the principles of the invention. FIG. 10 is a conceptual view illustrating tire information stored in the storage medium of FIG. 9.

Referring to FIG. 9, a vehicle control system 900 may include a tire pressure monitoring system 710, a main controller 920, a speed detector 930, and a storage medium 940. The tire pressure monitoring system 710 may be configured the same as the tire pressure monitoring system 710 of FIG. 7.

The main controller 920 is coupled to the tire pressure monitoring system 710, the speed detector 930, and the storage medium 940. The main controller 920 may generate an alert signal based on the detection of the wear indication peak positioned between the first and second frequencies and whether the vehicle moves at a speed in a target range. The main controller 920 may receive the vehicle speed information from the speed detector 930. The target range information may be stored in the vehicle system 900, for example, the storage medium 940, and the main controller 920 may access the storage medium 940 to read the target range information.

As described with reference to FIGS. 5 and 6A through 6E, the wear indication peak may occur at a frequency varying depending on the vehicle speed. Given that the tread features of the tire are configured to generate the wear indication peak positioned between the first and second frequencies when the vehicle moves at a speed in the target range, and that the frequency spectrum of the harmonic noise signal may vary to have an undesired frequency peak depending on various factors associated with the tire, the alert signal generated based on the vehicle speed as well as the wear indication peak may have relatively high reliability to indicate tire and/or tread wear.

The target speed range may vary depending on the tire. Therefore, the target speed range suitable for the tire may improve the reliability of the alert signal.

The main controller 920 may determine the target speed range based on the number of the tread features. The main controller 920 may determine the number of the tread features based on input information provided by the user through one of various user interfaces which may interact with the vehicle system 900. The input information may be associated with the number of the tread features and a diameter of the tire.

The main controller 920 may calculate the target speed range depending on the the number of the tread features and the tire diameter. The target speed range may be inversely proportional to the number of the tread features, and proportional to the tire diameter. For example, the main controller 920 may determine the two boundaries of the target speed range according to Equation 1.

$$V = \frac{f \times ( CC \times D )}{N} \times AC \qquad Eq . 1$$

In Equation 1, V denotes one of the two boundaries of the target speed range, f denotes one of the first and second frequencies of the first and second cavity noise peaks of the frequency spectrum of the harmonic noise signal, D denotes the tire diameter, N denotes the number of the tread features, CC denotes a circular constant which is fixed, and AC denotes an adjustable constant. The first and second frequencies may be substantially constant regardless of the vehicle speed, and may be predetermined. As such, the main controller 920 may determine the target speed range to be inversely proportional to the number of the tread features and proportional to the tire diameter.

In an exemplary embodiment, the input information may include a tire identifier, and the storage medium 940 may store the number of the tread features and the tire diameter corresponding to each of a plurality of tire identifiers. Referring to FIG. 10, each of first to n-th tire identifiers ID1 to IDn is mapped with a tread index and a tire diameter. The tread index may indicate the number of the tread features of the tire. The first tire identifier ID1 has a first tread index TRDI1 and a first tire diameter TD1, the second tire identifier ID2 has a second tread index TRDI2 and a second tire diameter TD2, and the n-th tire identifier IDn has an n-th tread index TRDIn and an n-th tire diameter TDn. In this manner, the main controller 920 may select one of the first to n-th tire identifiers ID1 to IDn matched with the input information, and select the tread index and the tire diameter corresponding to the selected tire identifier to calculate the target speed range.

In an exemplary embodiment, the storage medium 940 may store speed range information corresponding to each of a plurality of tire identifiers, and the main controller 920 may access the storage medium 940 with the input information to determine the target speed range. In FIG. 10, each of first to n-th tire identifiers ID1 to IDn is further mapped with the speed range. For example, the first tire identifier ID1 has a first speed range SR1, the second tire identifier ID2 has a second speed range SR2, and the n-th tire identifier IDn has an n-th speed range SRn. The main controller 920 may select one of the first to n-th tire identifiers ID1 to IDn matched with the input information, and select one of the first to n-th speed ranges SR1 to SRn corresponding to the selected tire identifier as the target speed range.

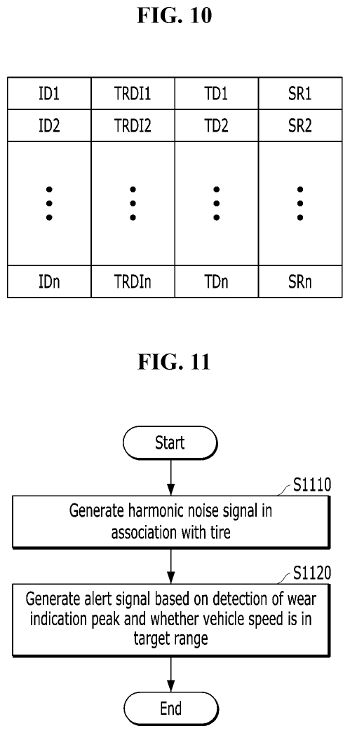

FIG. 11 is a flowchart of another exemplary embodiment of a method of generating an alert signal to indicate a tire worn out.

Referring to FIG. 11, at step S1110, a harmonic noise signal is generated using an acoustic sensor associated with a tire when the tire rolls to move the vehicle. The tire includes tread features in a range of 16 to 96, and more specifically, in a range of 24 to 56, which cause a wear indication peak.

At step S1120, an alert signal is generated based on detection of the wear indication peak and whether the vehicle speed is in a target range. Since the alert signal is generated further based on the vehicle speed, the alert signal may have relatively high reliability to indicate tire and/or tread wear. The target range may be adjusted suitable for the tire to improve the reliability of the alert signal.

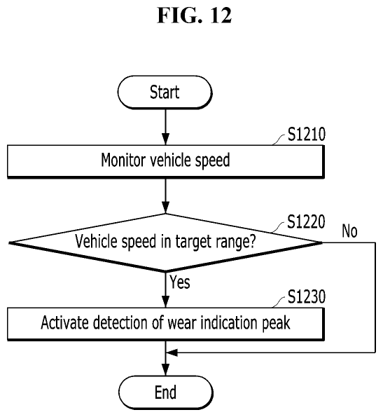

FIG. 12 is a flowchart of an exemplary embodiment of the step S1120 of FIG. 11.

Referring to FIG. 12, at step S1210, the vehicle speed is monitored. The step S1210 may be performed by the speed detector 930 of FIG. 9. The vehicle speed may be measured in various manners known in the art.

At step S1220, it is determined that whether the vehicle speed is in the target range. If the vehicle moves at a speed in the target range, step S1230 is performed.

At step S1230, detection of the wear indication peak is activated. The detection of the wear indication peak is deactivated when the vehicle speed is out of the target range. Accordingly, the power required to perform the operations for the detection of the wear indication peak may be reduced as well.

In an exemplary embodiment, the main controller 920 of FIG. 9 may generate a command signal in response to the vehicle speed being in the target range, and the local controller 711 of FIG. 9 and/or the main controller 920 may activate the operations for the detection of the wear indication peak in response to the command signal. For example, the local controller 711 and/or the main controller 920 may generate the frequency spectrum of the harmonic noise signal and monitor the frequency spectrum to detect the wear indication peak positioned between the first and second frequencies.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A tire for a vehicle, comprising:
a tread extending in a circumferential direction about a rotational axis of the tire; and
wear indicators disposed in the tread and spaced apart from each other to be arranged in the circumferential direction,
wherein a harmonic noise signal caused by the tire when the tire rolls on a road surface to move the vehicle has neighboring first and second frequency peaks in a frequency spectrum of the harmonic noise signal, and
wherein the number of the wear indicators is in a range of 16 to 96 to generate, and when the tire rolls to move the vehicle at a speed in a target range, the wear indicators cause an additional frequency peak positioned between the first and second frequency peaks in the frequency spectrum when the tread is worn to reach a wear threshold.

2. The tire of claim 1, wherein the first and second frequency peaks have substantially constant frequencies regardless of the speed of the vehicle.

3. The tire of claim 1, wherein the harmonic noise signal has a plurality of frequency peaks in the frequency spectrum, and the first and second frequency peaks have lowest frequencies from among the plurality of frequency peaks.

4. The tire of claim 1, wherein:
the tread comprises tread patterns defining grooves;
the grooves are spaced apart from each other to be arranged in the circumferential direction; and
the wear indicators comprises tread features disposed on surfaces of the grooves.

5. The tire of claim 1, wherein the wear indicators comprises tread features buried in the tread.

6. The tire of claim 1, wherein the wear indicators is configured to generate an acoustic signal to provide the additional frequency peak in the frequency spectrum when the tread is worn to reach the wear threshold.

7. The tire of claim 1, wherein the first frequency peak has a frequency of about 200 Hz, and the second frequency peak has a frequency of about 400 Hz.

8. The tire of claim 1, wherein the number of the wear indicators is in a range of 24 to 56.

9. The tire of claim 1, wherein the number of the wear indicators is 32.

10. A tire wear detection system for a vehicle, comprising:
a tire including:
a tread extending in a circumferential direction about a rotational axis of the tire; and
wear indicators disposed in the tread and spaced apart from each other to be arranged in the circumferential direction, the number of the wear indicators being in a range of 16 to 96;
at least one sensor to generate a harmonic noise signal in association with the tire when the tire rolls on a road surface to move the vehicle, the harmonic noise signal having neighboring first and second frequency peaks in a frequency spectrum of the harmonic noise signal;
at least one processor to generate an alert signal based on detection of an additional frequency peak caused by the wear indicators and positioned between the first and second frequency peaks in the frequency spectrum.

11. The tire wear detection system of claim 10, wherein the first and second frequency peaks have substantially constant frequencies regardless of the speed of the vehicle.

12. The tire wear detection system of claim 10, wherein the harmonic noise signal has a plurality of frequency peaks in the frequency spectrum, and the first and second frequency peaks have lowest frequencies from among the plurality of frequency peaks.

13. The tire wear detection system of claim 10, wherein the at least one processor is configured to generate the alert signal further based on whether the vehicle moves at a speed in a target range.

14. The tire wear detection system of claim 13, wherein the at least one processor is configured to activate the detection of the additional frequency peak in response to the speed of the vehicle being in the target range.

15. The tire wear detection system of claim 13, wherein the at least one processor is configured to calculate the target range depending on the number of the wear indicators and a diameter of the tire,
the target range is inversely proportional to the number of the tread features and proportional to the diameter of the tire.

16. The tire wear detection system of claim 13, wherein the at least one processor is configured to determine the number of the wear indicators and the diameter of the tire based on input information.

17. The tire wear detection system of claim 16, further comprising a storage medium to store indices and diameters corresponding to tire identifiers,
wherein the at least one processor is configured to:
select one of the indices and one of the diameters that correspond to one of the tire identifiers matched with the input information; and
determine the selected index and the selected diameter as the number of the wear indicators and the diameter of the tire.

18. The tire wear detection system of claim 13, further comprising a storage medium to store speed ranges corresponding to tire identifiers,
wherein the at least one processor is configured to:
select one of the speed ranges which corresponds to one of the tire identifiers matched with input information; and
determine the selected speed range as the target range.

19. The tire wear detection system of claim 10, wherein the at least one sensor comprises an acoustic sensor to detect a harmonic acoustic signal generated by the tire to generate the harmonic noise signal.

20. A method of generating an alert signal to indicate a tire worn to reach a wear threshold, the method comprising steps of:
generating harmonic noise signal in association with the tire when the tire rolls on a road surface to move a vehicle, the harmonic noise signal having neighboring first and second frequency peaks in a frequency spectrum of the harmonic noise signal,
wherein the tire includes:
a tread extending in a circumferential direction about a rotational axis of the tire; and
wear indicators disposed in the tread and spaced apart from each other to be arranged in the circumferential direction, the number of the wear indicators being in a range of 16 to 96; and
generating an alert signal based on detection of an additional frequency peak caused by the wear indicators and positioned between the first and second frequency peaks in the frequency spectrum.
